(19) United States
(12) Patent Application Publication
(10) Pub. No.: US 2017/0109214 A1
(43) Pub. Date: Apr. 20, 2017

(54) Accelerating Task Subgraphs By Remapping Synchronization

(71) Applicant: QUALCOMM Incorporated, San Diego, CA (US)

(72) Inventors: Arun Raman, Fremont, CA (US); Tushar Kumar, San Francisco, CA (US)

(21) Appl. No.: 14/885,226

(22) Filed: Oct. 16, 2015

(51) Int. Cl. G06F 9/52; G06F 17/30

(52) U.S. Cl. CPC G06F 9/52; G06F 17/30958; G06F 17/30424

(57) ABSTRACT

Embodiments include computing devices, apparatus, and methods implemented by a computing device for accelerating execution of a plurality of tasks belonging to a common property task graph. The computing device may identify a first successor task dependent upon a bundled task such that an available synchronization mechanism is a common property for the bundled task and the first successor task, and such that the first successor task only depends upon predecessor tasks for which the available synchronization mechanism is a common property. The computing device may add the first successor task to a common property task graph and add the plurality of tasks belonging to the common property task graph to a ready queue. The computing device may recursively identify successor tasks. The synchronization mechanism may include a synchronization mechanism for control logic flow or a synchronization mechanism for data access.

### BACKGROUND

Building applications that are responsive, high-performance, and power-efficient is crucial to delivering a satisfactory user experience. The task-parallel programming model is widely used to develop such applications. In this model, computation is encapsulated in asynchronous units called “tasks,” with the tasks coordinating or synchronizing among themselves through “dependencies.” Tasks may encapsulate computation on different types of computing devices such as a central processing unit (CPU), graphics processing unit (GPU), or digital signal processor (DSP). The power of the task parallel programming model and the notion of dependencies is that together they abstract away the device-specific computation and synchronization primitives, and simplify the expression of algorithms in terms of generic tasks and dependencies.

### SUMMARY

The methods and apparatuses of various embodiments provide circuits and methods for accelerating execution of a plurality of tasks belonging to a common property task graph on a computing device. Various embodiments may include identifying a first successor task dependent upon a bundled task such that an available synchronization mechanism is a common property for the bundled task and the first successor task, and such that the first successor task only depends upon predecessor tasks for which the available synchronization mechanism is a common property, adding the first successor task to a common property task graph, and adding the plurality of tasks belonging to the common property task graph to a ready queue.

Some embodiments may further include querying a component of the computing device for the available synchronization mechanism.

Some embodiments may further include creating a bundle for including the plurality of tasks belonging to the common property task graph, in which the available synchronization mechanism is a common property for each of the plurality of tasks, and in which each of the plurality of tasks depends upon the bundled task, and adding the bundled task to the bundle.

Some embodiments may further include setting a level variable for the bundle to a first value for the bundled task, modifying the level variable for the bundle to a second value for the first successor task, determining whether the first successor task has a second successor task, and setting the level variable to the first value in response to determining that the first successor task does not have a second successor task, in which adding the plurality of tasks belonging to the common property task graph to a ready queue may include adding the plurality of tasks belonging to the common property task graph to the ready queue in response to the level variable being set to the first value in response to determining that the first successor task does not have a second successor task.

In some embodiments, identifying a first successor task of the bundled task may include determining whether the bundled task has a first successor task, and determining whether the first successor task has the available synchronization mechanism as a common property with the bundled task in response to determining that the bundled task has the first successor task.

In some embodiments, identifying a first successor task of the bundled task may include deleting a dependency of the first successor task to the bundled task in response to determining that the first successor task has the available synchronization mechanism as a common property with the bundled task, and determining whether the first successor task has a predecessor task.

In some embodiments, identifying a first successor task of the bundled task is executed recursively until determining that the bundled task has no other successor task, and adding the plurality of tasks belonging to the common property task graph to a ready queue may include adding the plurality of tasks belonging to the common property task graph to the ready queue in response to determining that the bundled task has no other successor task.

Various embodiments may include a computing device having a memory and a plurality of processors communicatively connected to each other, including a first processor configured with processor-executable instructions to perform operations of one or more of the embodiment methods described above.

Various embodiments may include a computing device having means for performing functions of one or more of the embodiment methods described above.

Various embodiments may include a non-transitory processor-readable storage medium having stored thereon processor-executable instructions configured to cause a processor of a computing device to perform operations of one or more of the embodiment methods described above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating a computing device suitable for implementing an embodiment.

FIG. 2 is a component block diagram illustrating an example multi-core processor suitable for implementing an embodiment.

FIG. 3 is a schematic diagram illustrating an example task graph including a common property task graph according to an embodiment.

FIG. 4 is a process flow and signaling diagram illustrating an example of task execution without using common property task remapping synchronization.

FIG. 5 is a process flow and signaling diagram illustrating an example of task execution using common property task remapping synchronization according to an embodiment.

FIG. 6 is a process flow diagram illustrating an embodiment method for task execution.

FIG. 7 is a process flow diagram illustrating an embodiment method for task scheduling.

FIG. 8 is a process flow diagram illustrating an embodiment method for common property task remapping synchronization.

FIG. 9 is a process flow diagram illustrating an embodiment method for common property task remapping synchronization.

FIG. 10 is component block diagram illustrating an example mobile computing device suitable for use with the various embodiments.

FIG. 11 is component block diagram illustrating an example mobile computing device suitable for use with the various embodiments.

FIG. 12 is component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a multi-core programmable processor. While the various embodiments are particularly useful for mobile computing devices, such as smartphones, which have limited memory and battery resources, the embodiments are generally useful in any electronic device that implements a plurality of memory devices and a limited power budget in which reducing the power consumption of the processors can extend the battery-operating time of a mobile computing device. The term “computing device” may further refer to stationary computing devices including personal computers, desktop computers, all-in-one computers, work stations, super computers, mainframe computers, embedded computers, servers, home theater computers, and game consoles.

Embodiments include methods, and systems and devices implementing such methods for improving device performance by providing efficient synchronization of parallel tasks using scheduling techniques that remap common property task graph synchronizations to take advantage of device-specific synchronization mechanisms. The methods, systems, and devices may identify common property task graphs for remapping synchronization using device-specific synchronization mechanisms, and remap synchronization for the common property task graphs based on the device-specific synchronization mechanisms and existing task synchronizations. Remapping synchronization using device-specific synchronization mechanisms may include ensuring that dependent tasks only depend upon predecessor tasks for which an available synchronization mechanism is a common property. Dependent tasks are tasks that require a result or completion of one or more predecessor tasks before execution can begin (i.e., execution of dependent tasks depends upon a result or completion of at least one predecessor task).

Prior task scheduling typically involves a scheduler executing on a particular type of device, e.g., a central processing unit (CPU), enforcing inter-task dependencies and thereby scheduling task graphs in which tasks may execute on multiple types of devices, such as a CPU, a graphics processing unit (GPU), or a digital signal processor (DSP). Upon determining that a task is ready for execution, the scheduler may dispatch the task to the appropriate device, e.g., GPU. Upon completion of the task's execution by the GPU, the scheduler on the CPU is notified and takes action to schedule dependent tasks. Such scheduling often involves frequent round-trips between the various types of devices, purely for scheduling and synchronizing the execution of tasks in task graphs, resulting in suboptimal (in terms of performance, energy, etc.) task graph execution. Prior task scheduling fails to take into account the fact that each type of device, e.g., GPU or DSP, may have more optimized means to enforce inter-task dependencies. For example, GPUs have hardware command queues with a first-in first-out (FIFO) guarantee. The synchronization of tasks expressed through task interdependencies may be efficiently implemented by remapping synchronization from the domain of the abstract task interdependencies to the domain of device-specific synchronization. A determination may be made regarding whether device-specific synchronization mechanisms exist that may be implemented to aid in determining whether and how to remap the tasks synchronization. A query may be made to some or all of the devices to determine the available synchronization mechanisms. For example, the GPU may report hardware command queues, the GPU-DSP may report interrupt-driven signaling across the two, etc.

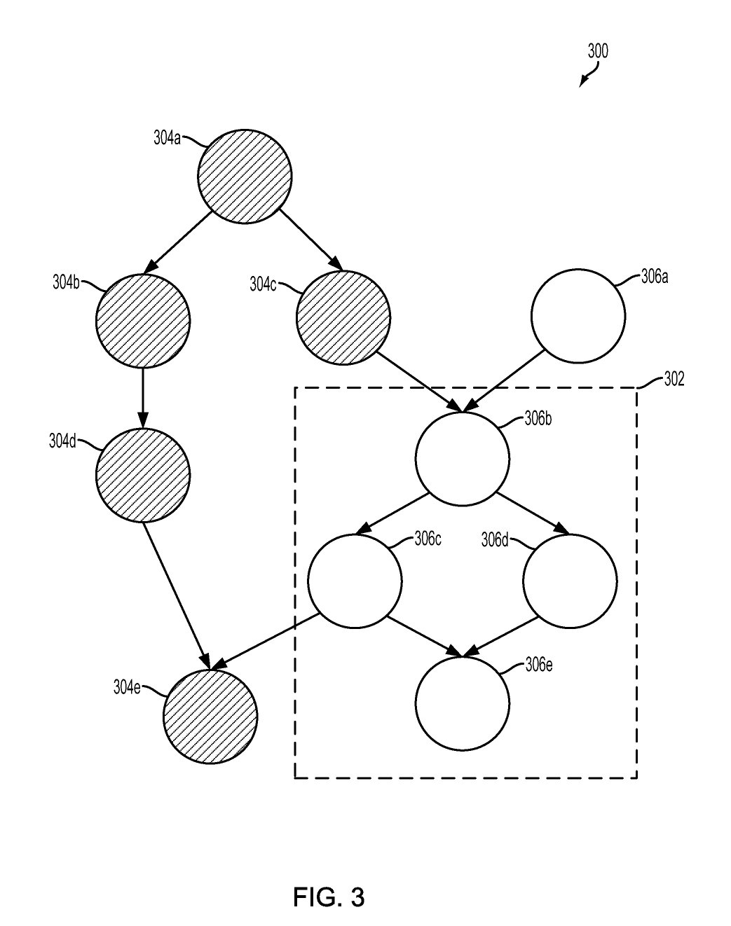

The queried synchronization mechanisms may be converted into properties of task graphs. All tasks in a task common property task graph may be related by a property. Some tasks in the overall task graph may be CPU tasks, GPU tasks, DSP tasks, or multiversioned tasks having specialized implementations on the GPU, DSP, etc. Based on the task properties of the tasks and their synchronizations, a common property task graph may be identified for remapping synchronization. The example in FIG. 3 shows a task graph with a common property task graph having tasks with the CPU task property or the GPU task property. When a task with a particular task property is ready, that task is added to a task bundle data structure. Successor tasks with the same property are considered for scheduling, and when the successor task becomes ready, such tasks are added to the same task bundle. When the last successor task is added to the task bundle, all of the tasks in the task bundle are deemed to be amenable for remapping synchronization.

To remap synchronization for a common property task graph, a determination may be made regarding whether a more efficient synchronization mechanism is available on the execution platform of the task property for the tasks of the task bundle. In response to identifying a more efficient synchronization mechanism that is available, each dependency in the common property task graph may be transformed into the corresponding synchronization primitive of the more efficient synchronization mechanism. After remapping all of the dependencies in the common property task graph, all of the tasks in the common property task graph may be dispatched for execution to the appropriate processor (e.g., GPU or DSP).

Prior to execution of the common property task graph, all of the resources required for executing the tasks of the common property task graph, such as memory buffers, may be identified and acquired, and then released up completion of the task(s) requiring the resource. During execution of the common property task graph, task completion signals may be sent to notify dependent tasks outside of the common property task graph of the completion of the task upon which the dependent task depends. Whether a task completion signal is sent after the completion of a task but before the completion of the common property task graph may depend on the dependency and criticality of the dependent task outside of the common property task graph.

The various embodiments provide a number of improvements in the operation of a computing device. The computing device may experience improved processing speed performance because bundling tasks to execute together on a common device and/or using common resources reduces the overhead for synchronizing dependent tasks across different devices and resources. Further, the different types of processors, such as a CPU and GPU, may be able to operate more efficiently in parallel as the tasks assigned to each processor are less dependent on each other. The computing device may experience improved power performance because of an ability to idle processors that are not used as a result of consolidating tasks to common processors and reduced communication overhead on shared busses used to synchronize the tasks. The various embodiments disclosed herein also provide a manner in which a computing device may map task graphs to specific processor without having an advanced scheduling framework.

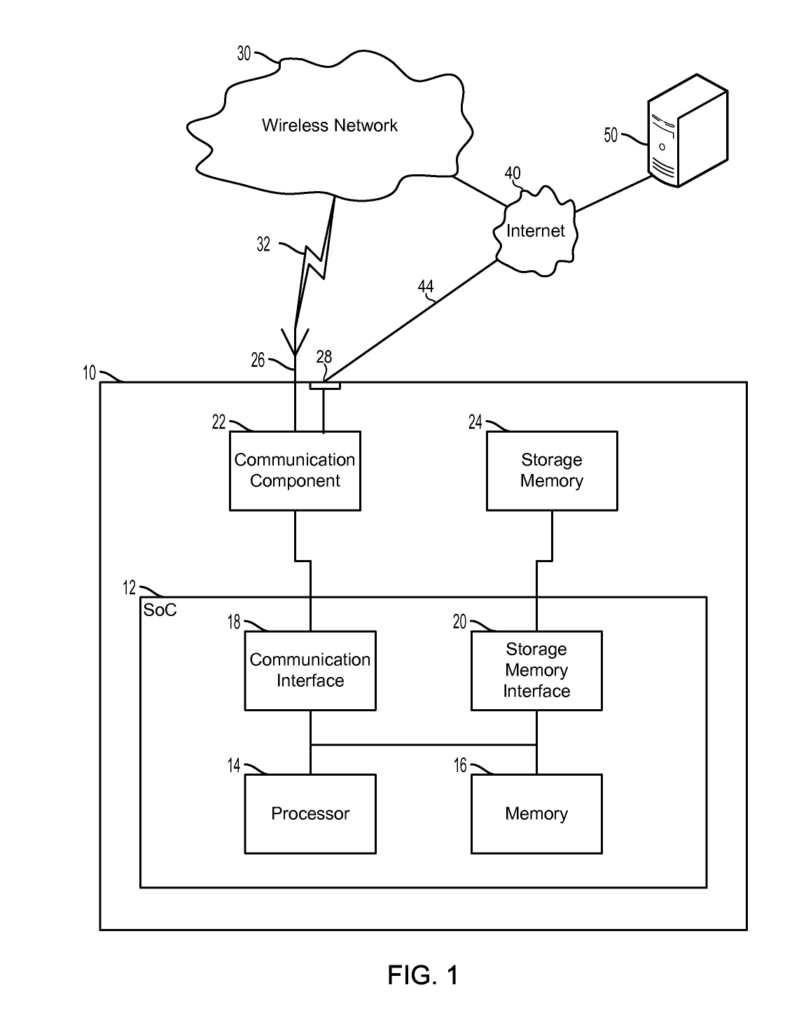

FIG. 1 illustrates a system including a computing device 10 in communication with a remote computing device 50 suitable for use with the various embodiments. The computing device 10 may include a system-on-chip (SoC) 12 with a processor 14, a memory 16, a communication interface 18, and a storage memory interface 20. The computing device may further include a communication component 22 such as a wired or wireless modem, a storage memory 24, an antenna 26 for establishing a wireless connection 32 to a wireless network 30, and/or the network interface 28 for connecting to a wired connection 44 to the Internet 40. The processor 14 may include any of a variety of hardware cores, for example a number of processor cores.

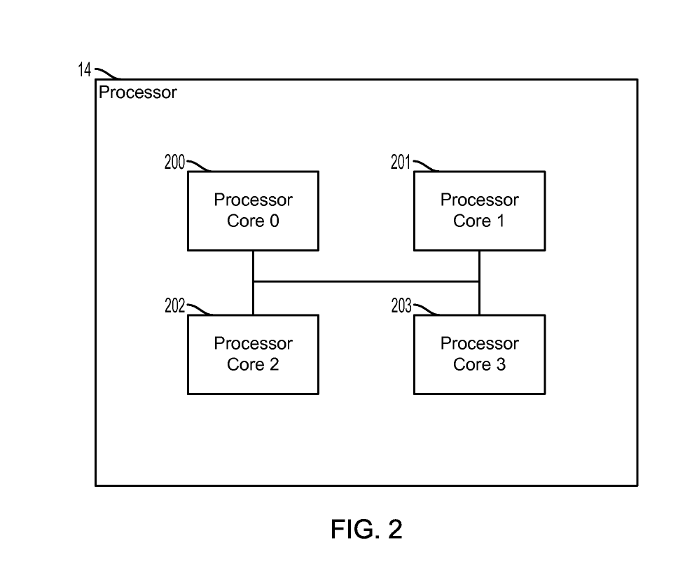

The term “system-on-chip” (SoC) is used herein to refer to a set of interconnected electronic circuits typically, but not exclusively, including a hardware core, a memory, and a communication interface. A hardware core may include a variety of different types of processors, such as a general purpose processor, a central processing unit (CPU), a digital signal processor (DSP), a graphics processing unit (GPU), an accelerated processing unit (APU), an auxiliary processor, a single-core processor, and a multi-core processor. A hardware core may further embody other hardware and hardware combinations, such as a field programmable gate array (FPGA), an application-specific integrated circuit (ASIC), other programmable logic circuit, discrete gate logic, transistor logic, performance monitoring hardware, watchdog hardware, and time references. Integrated circuits may be configured such that the components of the integrated circuit reside on a single piece of semiconductor material, such as silicon. The SoC 12 may include one or more processors 14. The computing device 10 may include more than one SoCs 12, thereby increasing the number of processors 14 and processor cores. The computing device 10 may also include processors 14 that are not associated with an SoC 12. Individual processors 14 may be multi-core processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. In an embodiment, one or more memories 16 may include volatile memories such as random access memory (RAM) or main memory, or cache memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a miss, because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

In an embodiment, the memory 16 may be configured to store raw data, at least temporarily, that is loaded to the memory 16 from a raw data source device, such as a sensor or subsystem. Raw data may stream from the raw data source device to the memory 16 and be stored by the memory until the raw data can be received and processed by a machine learning accelerator as discussed further herein with reference to FIGS. 3-19.

The communication interface 18, communication component 22, antenna 26, and/or network interface 28, may work in unison to enable the computing device 10 to communicate over a wireless network 30 via a wireless connection 32, and/or a wired network 44 with the remote computing device 50. The wireless network 30 may be implemented using a variety of wireless communication technologies, including, for example, radio frequency spectrum used for wireless communications, to provide the computing device 10 with a connection to the Internet 40 by which it may exchange data with the remote computing device 50.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information even after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be differently arranged and/or combined while still serving the necessary functions. Moreover, the computing device 10 may not be limited to one of each of the components, and multiple instances of each component may be included in various configurations of the computing device 10.

FIG. 2 illustrates a multi-core processor 14 suitable for implementing an embodiment. The multi-core processor 14 may have a plurality of homogeneous or heterogeneous processor cores 200, 201, 202, 203. The processor cores 200, 201, 202, 203 may be homogeneous in that, the processor cores 200, 201, 202, 203 of a single processor 14 may be configured for the same purpose and have the same or similar performance characteristics. For example, the processor 14 may be a general purpose processor, and the processor cores 200, 201, 202, 203 may be homogeneous general purpose processor cores. Alternatively, the processor 14 may be a graphics processing unit or a digital signal processor, and the processor cores 200, 201, 202, 203 may be homogeneous graphics processor cores or digital signal processor cores, respectively. For ease of reference, the terms “processor” and “processor core” may be used interchangeably herein.

The processor cores 200, 201, 202, 203 may be heterogeneous in that, the processor cores 200, 201, 202, 203 of a single processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar embodiments, the SoC 12 may include a number of homogeneous or heterogeneous processors 14.

In the example illustrated in FIG. 2, the multi-core processor 14 includes four processor cores 200, 201, 202, 203 (i.e., processor core 0, processor core 1, processor core 2, and processor core 3). For ease of explanation, the examples herein may refer to the four processor cores 200, 201, 202, 203 illustrated in FIG. 2. However, the four processor cores 200, 201, 202, 203 illustrated in FIG. 2 and described herein are merely provided as an example and in no way are meant to limit the various embodiments to a four-core processor system. The computing device 10, the SoC 12, or the multi-core processor 14 may individually or in combination include fewer or more than the four processor cores 200, 201, 202, 203 illustrated and described herein.

FIG. 3 illustrates an example task graph 300 including a common property task graph 302 according to an embodiment. A common property task graph may consist of a group of tasks sharing a common property for execution with a single entry point. Common properties may include common properties for control logic flow, or common properties for data access. Common properties for control logic flow may include tasks that are executable by the same hardware using the same synchronization mechanism. For example, CPU-only executable tasks (CPU tasks) 304a-304e or GPU-only executable tasks (GPU tasks) 306a-306e may represent two different groups of tasks that share common properties for control logic flow based on the same hardware using the same synchronization mechanism. In an example, GPU task 306a may become a ready task and may be scheduled for dispatch to the GPU before CPU task 304c completes execution, preventing GPU task 306b from becoming a ready task. Therefore, the GPU task 306a may be dispatched before the GPU tasks 306b-306e, excluding GPU task 306a from the common property task graph 302. In a further example, GPU tasks 306b-306e may require a different synchronization mechanism from GPU task 306a, e.g., different buffers for tasks of programming languages based on different application programming interfaces (APIs), such as a buffer for OpenCL based programming languages and a buffer for OpenGL based programming languages. Therefore, the GPU task 306a may be excluded from the common property task graph 302. Common properties for data access may include access by multiple tasks to the same data storage devices, and may further include types of access to the data storage device. For example, the tasks of a common property task graph may all require access to the same data buffer, and they may be grouped together for execution by the same hardware while accessing the same data storage device. In a further example, tasks requiring read only access may be grouped in a separate common property task graph from task requiring read/write access. Common property task graphs may further be defined by a single entry point into the common property task graph, which may include a task that all of the other tasks of the common property task graph depend upon and do not depend upon any task outside of the common property task graph. Common property task graphs may have multiple exit dependencies, such that tasks outside of the common property task graphs may depend upon various tasks of the common property task graphs.

In the example illustrated in FIG. 3, CPU tasks 304a-304e and GPU tasks 306a-306e can be related to each other through dependencies, illustrated by the arrows connecting the individual tasks 304a-304e, 306a-306e. Among the tasks 304a-304e, 306a-306e, the computing device may identify the common property task graph 302 including GPU tasks 306b-306e that may be GPU-only executed. For the common property task graph 302, the entry point can be GPU task 306b, where GPU task 306b is the only one of GPU tasks 306b-306e that is dependent upon a CPU task 304a-304e, e.g., CPU task 304c. In this example, the common property task graph 302 also includes GPU task 306c and GPU task 306d, which are dependent on GPU task 306b but not each other, and GPU task 306e is dependent upon GPU tasks 306c and 306d. Further, GPU task 306c may include an exit dependency such that CPU task 304e depends upon GPU task 306c. As described in further detail herein, with reference to FIGS. 5, and 7-9, the common property task graph 302 may be represented a bundle of the GPU tasks 306b-306e such that all of the GPU tasks 306b-306e of the common property task graph 302 may be scheduled for execution together by the same hardware and synchronization mechanism.

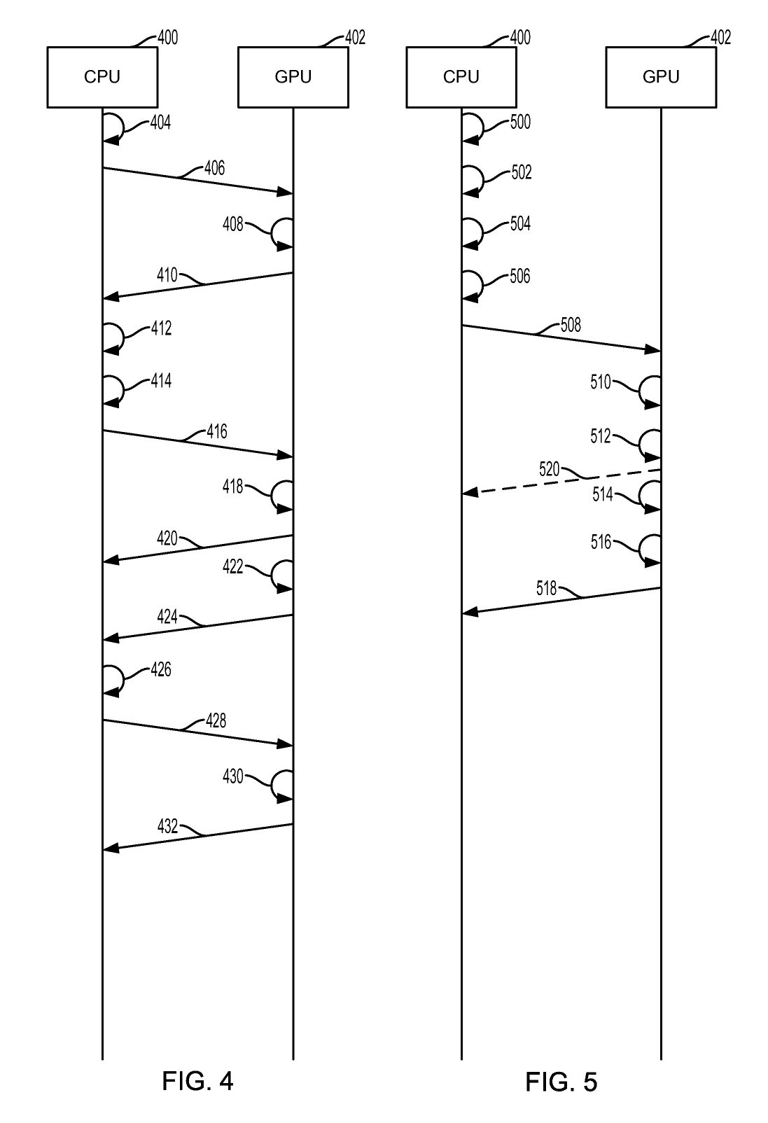

FIG. 4 illustrates an example of task execution without using common property task remapping synchronization, as known in the prior art. While the task-parallel programming model provides programming convenience, it can cause performance degradation. Execution of task-parallel program may result in a ping-pong effect of scheduling dependent tasks for execution on different hardware such that resource heavy communication must be implemented between the different hardware to notify a scheduler of the completion of a predecessor task.

Using the GPU tasks 306b-306e described with reference to FIG. 3 as an example, the GPU task 306b is scheduled for execution 404 on the GPU 402 by the CPU 400. As soon as the GPU task 306b becomes ready for execution (in task scheduling, a task is said to be ready when all its predecessor tasks have finished execution), it is dispatched 406 to the GPU 402. The GPU 402 executes 408 the GPU task 306b. When the GPU task 306b finishes, the CPU 400 is notified 410. In turn the CPU 400 determines that the GPU tasks 306c and 306d are both ready, the GPU tasks 306c and 306d are scheduled for execution 412, 414 on the GPU 402, and are dispatched 416 to the GPU 402. The GPU tasks 306c and 306d are each executed 418, 422 by the GPU 402. The CPU 400 is notified 420, 424 of the completion of the execution of each of the GPU tasks 306c and 306d. The CPU 400 determines that the GPU task 306e is ready, schedules 426 the GPU task 306e for execution by the GPU 402, and dispatches 428 the GPU task 306e to the GPU 402. The GPU task 306e is executed 430 by the GPU 402 which notifies 432 the CPU 400 of the completed execution of the GPU task 306e. This process proceeds until the entire task graph, in this example a task graph including GPU task 306b-306e, is processed. The back-and-forth roundtrips between the CPU 400 and GPU 402 to schedule tasks for execution in succession by the GPU 402 often introduces sufficient delay that it offsets any benefits gained by offloading tasks to the GPU 402.

FIG. 5 illustrates an example of task execution using common property task remapping synchronization according to an embodiment. Using the common property task graph 302, including the GPU tasks 306b-306e, described with reference to FIG. 3 as an example, the GPU tasks 306b-306e may all be scheduled for execution 500-506 on the GPU 402 by the CPU 400. As soon as the GPU task 306b becomes ready for execution, the GPU tasks 306b-306e may be dispatched 508 to the GPU 402. The GPU 402 may execute 510-516 the GPU tasks 306b-306e, the order of execution may be dictated by the dependencies between the GPU tasks 306b-306e and how they are scheduled. Upon completion of the execution of the GPU task 306b-306e, the CPU 400 may be notified 518 of the completion of all of the GPU task 306b-306e.

In various embodiments, a GPU task of the common property task graph 302 may have a dependent successor task outside of the common property task graph 302. For example, the GPU task 306c may have a successor task, the CPU task 304e dependent upon the GPU task 306c. Notification of the completion of the GPU task 306c to the CPU 400 may occur at the end of the completion of the entire common property task graph 302 as described herein. Thus, the CPU task 304e may not be scheduled for execution until the completion of common property task graph 302. Alternatively, the CPU 400 may optionally be notified 520 of the completion of the predecessor task, like GPU task 306c, after completion of the predecessor task, rather than waiting for the completion of the common property task graph 302. Whether to implement these various embodiments may depend on a criticality of the successor task. The more critical a successor task, the more likely the notification may be closer in time to the completion of the predecessor task. Criticality may be a measure of how the delay of the execution of the successor task may increase the latency of the execution of task graph 300. The greater the influence the successor task has on the latency of the task graph 300, the more critical the successor task may be.

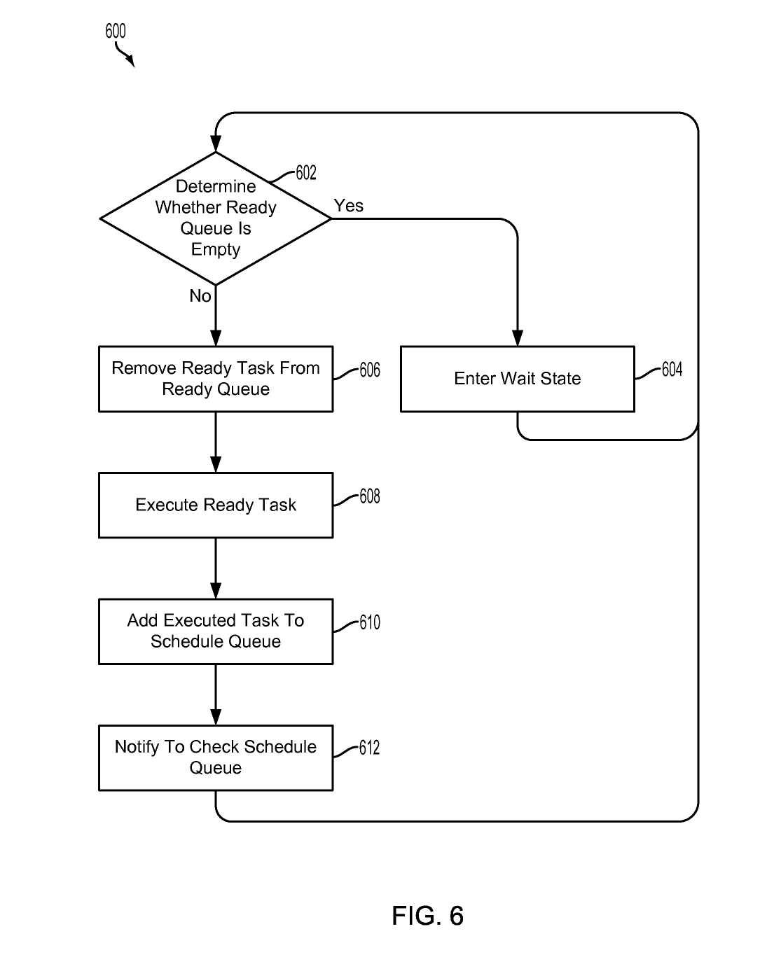

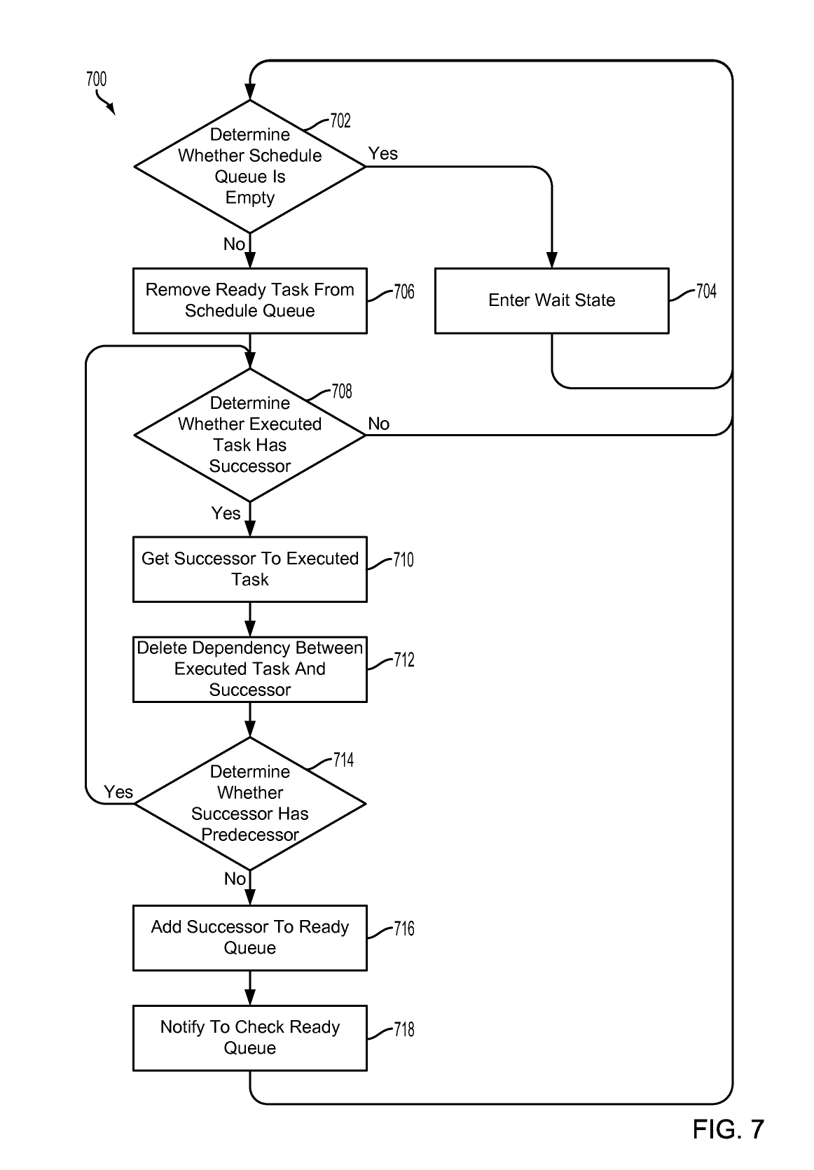

FIG. 6 illustrates an embodiment method 600 for task execution. The method 600 may be implemented in a computing device in software executing in a processor, in general purpose hardware, or dedicated hardware. In various embodiments, the method 600 may be implemented by multiple threads on multiple processors or hardware components. In various embodiments, the method 600 may be implemented concurrently with other methods described further herein with reference to FIGS. 7-9.

In determination block 602, the computing device may determine whether a ready queue is empty. A ready queue may be a logical queue implemented by one or more processors, or a queue implemented in general purposed or dedicated hardware. The method 600 may be implemented using multiple ready queues; however, for the sake of simplicity, the descriptions of the various embodiments reference a single ready queue. When the ready queue is empty, the computing device may determine that there are no pending tasks that are ready for execution. In other word, there are either no tasks waiting for execution, or there is a task waiting for execution, but it is dependent on a predecessor task which has no finished executing. When the ready queue is populated with at least one task, or is not empty, the computing device may determine that there is a task waiting for execution that is not dependent upon a predecessor task or is no longer waiting for a predecessor task to complete.

In response to determining that the ready queue is empty (i.e., determination block 602=“Yes”), the computing device may enter into a wait state in optional block 604. In various embodiments the computing device may be triggered to exit the wait state and determine whether the ready queue is empty in determination block 602. The computing device may be triggered to exit the wait state after a parameter is met, such as a timer expiring, an application initiating, or a processor waking up, or in response to a signal that an executing task is completed. In various embodiments where optional block 604 is not implemented, the computing device may determine whether the ready queue is empty in determination block 602.

In response to determining that the ready queue is not empty (i.e., determination block 602=“No”), the computing device may remove a ready task from the ready queue in block 606. In block 608 the computing device may execute the ready task. In various embodiments, the ready task may be executed by the same component executing the method 600, by suspending the method 600 to execute the ready task and resuming the method 600 after completion of the ready task, by using multi-threading capabilities, or by using available parts of the component, such as an available processor core of a multi-core processor.

In various embodiments, the component implementing the method 600 may provide the ready task to an associated component for executing ready tasks from a specific ready queue. In block 610, the computing device may add the executed task to a schedule queue. In various embodiments, the schedule queue may be a logical queue implemented by one or more processors, or a queue implemented in general purposed or dedicated hardware. The method 600 may be implemented using multiple ready queues; however, for the sake of simplicity, the descriptions of the various embodiments reference a single ready queue.

In block 612, the computing device may notify or otherwise prompt a component to check the schedule queue.

FIG. 7 illustrates an embodiment method 700 for task scheduling. The method 700 may be implemented in a computing device in software executing in a processor, in general purpose hardware, or dedicated hardware. In various embodiments, the method 700 may be implemented by multiple threads on multiple processors or hardware components. In various embodiments, the method 700 may be implemented concurrently with other methods described with reference to FIGS. 6, 8, and 9.

In determination block 702, the computing device may determine whether the schedule queue is empty. As noted with reference to FIG. 6, in various embodiments, the schedule queue may be a logical queue implemented by one or more processors, or a queue implemented in general purposed or dedicated hardware. The method 700 may be implemented using multiple ready queues; however, for the sake of simplicity, the descriptions of the various embodiments reference a single ready queue.

In response to determining that the schedule queue is empty (i.e., determination block 702=“Yes”), the computing device may enter into a wait state in optional block 704. In various embodiments the computing device may be triggered to exit the wait state and determine whether the schedule queue is empty in determination block 702. The computing device may be triggered to exit the wait state after a parameter is met, such as a timer expiring, an application initiating, or a processor waking up, or in response to a signal, like the notification described with reference to FIG. 6 in block 612. In various embodiments where optional block 704 is not implemented, the computing device may determine whether the schedule queue is empty in determination block 702.

In response to determining that the schedule queue is not empty (i.e., determination block 702=“No”), the computing device may remove the executed task from the schedule queue in block 706.

In determination block 708, the computing device may determine whether the executed task removed from the schedule queue has any successor tasks, i.e. tasks that depend upon the executed task. A successor task of the executed task may be any task that is directly dependent upon the executed task. The computing device may analyze dependencies to and upon tasks to determine their relationships to other tasks. A successor task of the executed task may or may not be ready tasks since their predecessor task was executed as this may depend on whether the successor task has other predecessor tasks that have not been executed.

In response to determining that the executed task does not have a successor task (i.e., determination block 708=“No”), the computing device may determine whether the schedule queue is empty in determination block 702.

In response to determining that the executed task does have a successor task (i.e., determination block 708=“Yes”), the computing device may obtain the task that is the successor to the executed task (i.e., the successor task) in block 710. In various embodiments, the executed task may have multiple successor tasks, and the method 700 may be executed for each of the successor tasks in parallel or serially.

In block 712, the computing device may delete the dependency between the executed task and its successor task. As a result of deleting the dependency between the executed task and its successor task, the executed task may no longer be a predecessor task to the successor task.

In determination block 714, the computing device may determine whether the successor task has a predecessor task. Like identifying the successor tasks in block 708, the computing device may analyze the dependencies between tasks to determine whether a task directly depends upon another task, i.e., whether the dependent task has a predecessor task. As noted above, the executed task may no longer be a predecessor task for the successor task, therefore the computing device may be checking for predecessor tasks other than the executed task.

In response to determining that the successor task does have a predecessor task (i.e., determination block 714=“Yes”), the computing device may determine whether the executed task removed from the schedule queue has any successor tasks in determination block 708.

In response to determining that the successor task does not have a predecessor task (i.e., determination block 714=“No”), the computing device may add the successor task to the ready queue in block 716. In various embodiments, when the successor task does not have any predecessor tasks upon which the successor task must wait to complete before being implemented, the successor task may become a ready task. In block 718, the computing device may notify or otherwise prompt a component to check the ready queue.

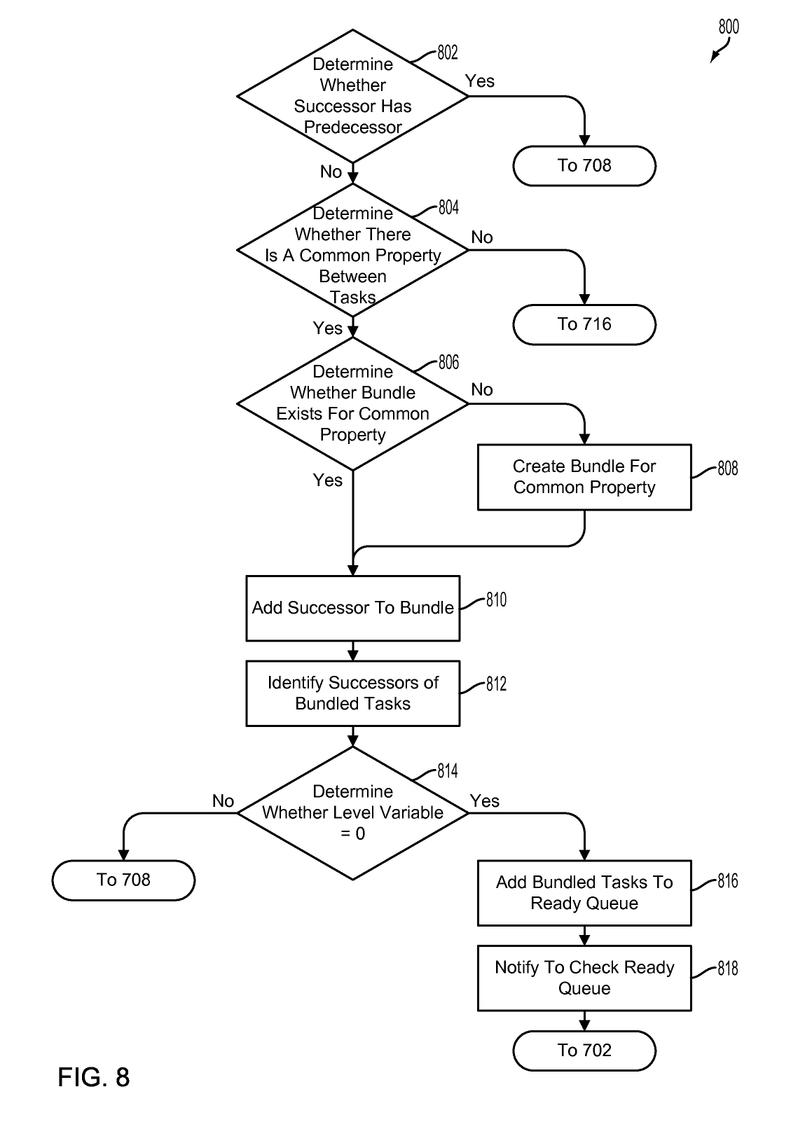

FIG. 8 illustrates an embodiment method 800 for common property task remapping synchronization. The method 800 may be implemented in a computing device in software executing in a processor, in general purpose hardware, or dedicated hardware. In various embodiments, the method 800 may be implemented by multiple threads on multiple processors or hardware components. In various embodiments, the method 800 may be implemented concurrently with other methods described further herein with reference to FIGS. 6, 7, and 9. In various embodiments, the method 800 may be implemented in place of determination block 714 of the method 700 as described with reference to FIG. 7.

In determination block 802, the computing device may determine whether the successor task has a predecessor task. As noted above, the executed task may no longer be a predecessor task for the successor task, therefore the computing device may be checking for predecessor tasks other than the executed task.

In response to determining that the successor task does have a predecessor task (i.e., determination block 802=“Yes”), the computing device may determine whether the executed task removed from the schedule queue has any successor tasks in determination block 708 of the method 700 described with reference to FIG. 7.

In response to determining that the successor task does not have a predecessor task (i.e., determination block 802=“No”), the computing device may determine whether the successor task shares a common property with other tasks in determination block 804. In making this determination, the computing device may query components of the computing device to determine the synchronization mechanisms that are available for executing the tasks. The computing device may match execution characteristics of the tasks to the synchronization mechanisms available. The computing device may compare tasks with characteristic that correspond with available synchronization mechanisms to other tasks to determine whether they have common properties.

Common properties may include common properties for control logic flow, or common properties for data access. Common properties for control logic flow may include task that are executable by the same hardware using the same synchronization mechanism. For example, CPU-only executable tasks, GPU-only executable tasks, DSP-only executable tasks, or any other specific hardware-only executable tasks. In a further example, specific hardware-only executable tasks may require a different synchronization mechanism from tasks executable only by the same specific hardware, such as using different buffers for tasks based on different programming languages. Common properties for data access may include access by multiple tasks to the same data storage devices, including volatile and non-volatile memory devices. Common properties for data access may further include types of access to the data storage device. For example, common properties for data access may include access to the same data buffer. In a further example, common properties for data access may include read only or read/write access.

In response to determining that the successor task does not share a common property with another task (i.e., determination block 804=“No”), the computing device may add the successor task to the ready queue in block 716 of the method 700 as described with reference to FIG. 7.

In response to determining that the successor task does share a common property with another task (i.e., determination block 804=“Yes”), the computing device may determine whether a bundle exists for tasks sharing the common property in determination block 806. As described further herein, the tasks sharing the common property may be bundled together so that they may be scheduled together for execution using the common property.

In response to determining that a bundle does not exists for tasks sharing the common property (i.e., determination block 806=“No”), the computing device may create a bundle for tasks sharing the common property in block 808. In various embodiments, the bundle may include a level variable to indicate a level of the tasks within the bundle such that the first task added to the bundle is at a defined level, for example at a depth of “0”. In block 810, the computing device may add the successor task to the created bundle for tasks sharing the common property.

In response to determining that a bundle does exists for tasks sharing the common property (i.e., determination block 806=“Yes”), the computing device may add the successor task to the existing bundle for tasks sharing the common property in block 810.

The successor task added to the bundle may be referred to as the bundled task. In various embodiments, the bundle for tasks sharing the common property may include only tasks sharing the common property, of which only one of those tasks may be a task that is a ready task, and the rest of the tasks may be successor tasks of the ready task with varying degrees of separation from the ready task. Further, the successor tasks may not also be successor tasks to other tasks excluded from the bundle for tasks sharing the common property, i.e., tasks that do not share the common property. A task that is initially a successor task of an excluded task may still be added to the bundle in response to the excluded task being executed, thereby removing the dependency of the successor task upon the excluded task as described for block 712 of the method 700 with reference to FIG. 7. In as much, the tasks included in the bundle for tasks sharing the common property make up a common property task graph.

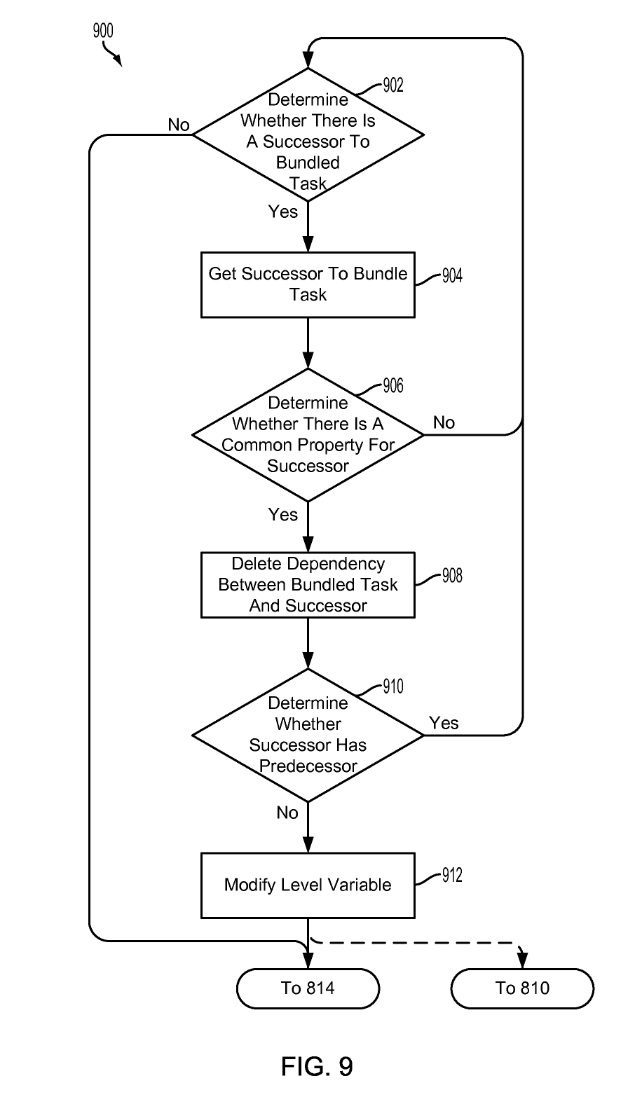

In block 812, the computing device may identify successor tasks of the bundled tasks sharing the common property for adding to the bundle for tasks sharing the common property. Identifying successor tasks of the bundled tasks sharing the common property is discussed in greater detail with reference to FIG. 9.

In determination block 814, the computing device may determine whether the level variable meets a designated relationship with the level of the first task added to the bundle, such as equaling the level of the first task added to the bundle.

In response to determining that the level variable does not meet the designated relationship with the level of the first task added to the bundle (i.e., determination block 814=“No”), the computing device may determine whether the executed task removed from the schedule queue has any successor tasks in determination block 708 of the method 700 described with reference to FIG. 7.

In response to determining that the level variable does meet the designated relationship with the level of the first task added to the bundle (i.e., determination block 814=“Yes”), the computing device may add the tasks of the bundle for tasks sharing the common property to the ready queue in block 816. In block 818, the computing device may notify or otherwise prompt a component to check the ready queue. The computing device may determine whether the schedule queue is empty as described for block 702 of the method 700 with reference to FIG. 7.

FIG. 9 illustrates an embodiment method 900 for common property task remapping synchronization. The method 900 may be implemented in a computing device in software executing in a processor, in general purpose hardware, or dedicated hardware. In various embodiments, the method 900 may be implemented by multiple threads on multiple processors or hardware components. In various embodiments, the method 900 may be implemented concurrently with other methods described further herein with reference to FIGS. 6-8. In various embodiments, the method 900 may be executed recursively until there are no more tasks that satisfy the conditions of the method 900. In various embodiments, the method 900 may be implemented in place of determination block 812 of the method 800 as described with reference to FIG. 8.

In determination block 902, the computing device may determine whether the bundled task has any successor tasks. In response to determining that the bundled task does not have a successor task (i.e., determination block 902=“No”), the computing device may determine whether the level variable meets the designated relationship with the level of the first task added to the bundle in determination block 814 of the method 800 described with reference to FIG. 8. Also, the task for which the method 900 is executed may be reset as described further herein.

In response to determining that the bundled task does have a successor task (i.e., determination block 902=“Yes”), the computing device may obtain the task that is the successor to the bundled task in block 904.

In determination block 906, the computing device may determine whether the successor task shares a common property with the bundled tasks. The determination of whether the successor task shares a common property with the bundled tasks may be implemented in a manner similar to the determination of whether the successor task shares a common property with other tasks in determination block 804 of the method 800 described with reference to FIG. 8. In various embodiments, the determination of whether the successor task shares a common property with the bundled tasks may be different in that it may only need to check for the common property shared among the bundled tasks, rather than check from a larger set of potential common properties.

In response to determining that the successor task does not share a common property with the bundled tasks (i.e., determination block 906=“No”), the computing device may determine whether the bundled task has any other successor tasks in determination block 902.

In response to determining that the successor task does share a common property with the bundled tasks (i.e., determination block 906=“Yes”), the computing device may delete the dependency between the bundled task and its successor task in block 908. As a result of deleting the dependency between the bundled task and its successor task, the bundled task may no longer be a predecessor task to the successor task. However, that does not necessarily imply that the bundled task and the successor task may execute out of order. Rather, the level variable assigned to each task in the bundle may be used to control the order in which the tasks are scheduled when the bundle is added to the ready queue, as in block 816 of the method 800 described with reference to FIG. 8.

In determination block 910, the computing device may determine whether the successor task to the bundled task has any predecessor tasks. In response to determining that the successor task to the bundled task has a predecessor task (i.e., determination block 910=“Yes”), the computing device may determine whether the bundled task has any other successor tasks in determination block 902.

In response to determining that the successor task to the bundled task does not have a predecessor task (i.e., determination block 910=“No”), the computing device may change the value of the level variable in a predetermined manner in block 912, such as incrementing the value of the level variable.

As noted above, the method 900 may be executed recursively, depicted by the dashed arrow, until there are no more tasks that satisfy the conditions of the method 900. As such, the successor task of the bundled task may be added to the common property tasks bundle at the current level indicated by the level variable in block 810 of the method 800 as described with reference to FIG. 8, and the method 900 may be repeated by the computing device using the newly bundled successor task.

In various embodiments, in response to determining that the newly bundled successor task does not have a successor task (i.e., determination block 902=“No”), the computing device may reset the task for which the method 900 is executed back to the first bundled task and determine whether the level variable meets the designated relationship with the level of the first task added to the bundle in determination block 814 of the method 800 described with reference to FIG. 8. In the example used herein, the level variable value for the bundled task meets the designated relationship with the level of the first task added to the bundle, e.g., is equal to “0”.

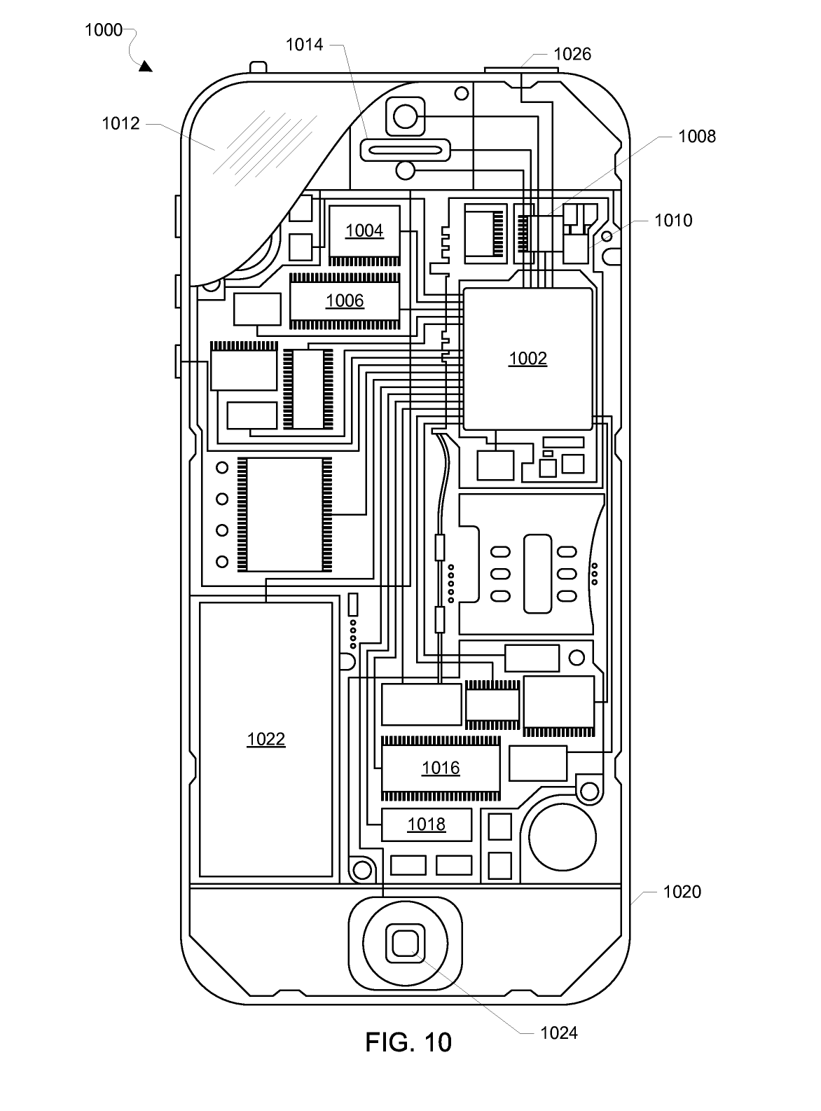

The various embodiments (including, but not limited to, embodiments discussed above with reference to FIGS. 1-9) may be implemented in a wide variety of computing systems, which may include an example mobile computing device suitable for use with the various embodiments illustrated in FIG. 10. The mobile computing device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the computing device 1000 need not have touch screen capability.

The mobile computing device 1000 may have one or more radio signal transceivers 1008 (e.g., Peanut, Bluetooth, Zigbee, Wi-Fi, RF radio) and antennae 1010, for sending and receiving communications, coupled to each other and/or to the processor 1002. The transceivers 1008 and antennae 1010 may be used with the above-mentioned circuitry to implement the various wireless transmission protocol stacks and interfaces. The mobile computing device 1000 may include a cellular network wireless modem chip 1016 that enables communication via a cellular network and is coupled to the processor.

The mobile computing device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as USB, FireWire, Thunderbolt, or PCIe. The peripheral device connection interface 1018 may also be coupled to a similarly configured peripheral device connection port (not shown).

The mobile computing device 1000 may also include speakers 1014 for providing audio outputs. The mobile computing device 1000 may also include a housing 1020, constructed of a plastic, metal, or a combination of materials, for containing all or some of the components discussed herein. The mobile computing device 1000 may include a power source 1022 coupled to the processor 1002, such as a disposable or rechargeable battery. The rechargeable battery may also be coupled to the peripheral device connection port to receive a charging current from a source external to the mobile computing device 1000. The mobile computing device 1000 may also include a physical button 1024 for receiving user inputs. The mobile computing device 1000 may also include a power button 1026 for turning the mobile computing device 1000 on and off.

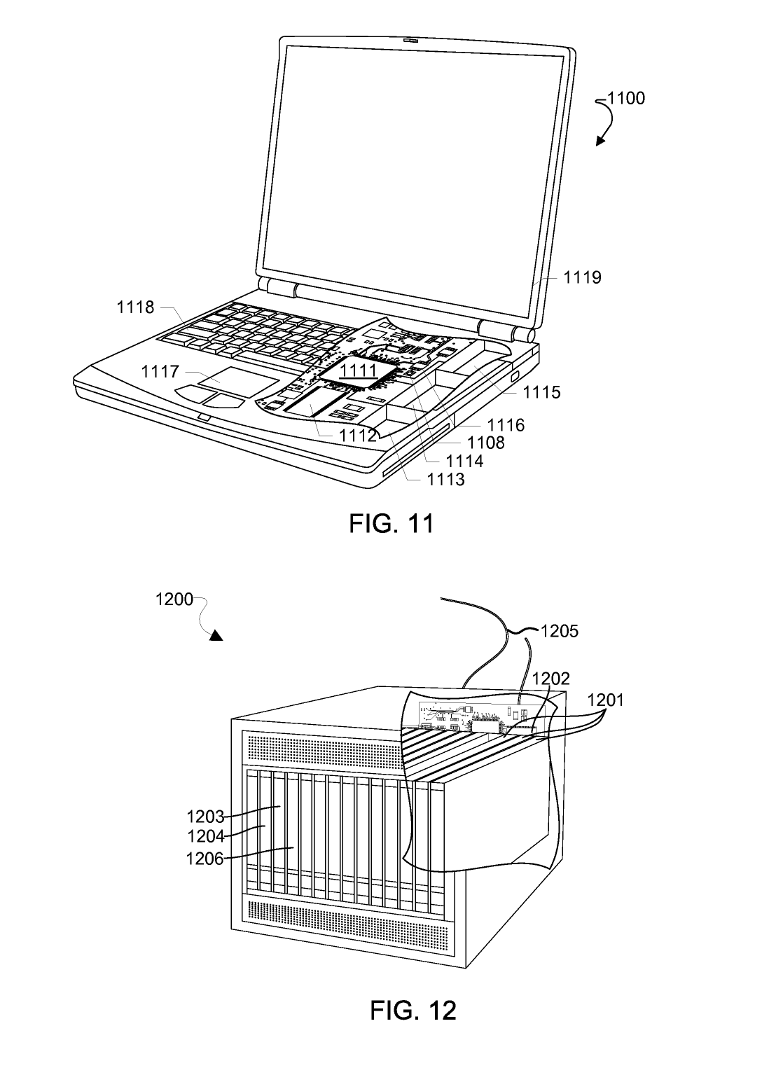

The various embodiments (including, but not limited to, embodiments discussed above with reference to FIGS. 1-9) may be implemented in a wide variety of computing systems, which may include a variety of mobile computing devices, such as a laptop computer 1100 illustrated in FIG. 11. Many laptop computers include a touchpad touch surface 1117 that serves as the computer's pointing device, and thus may receive drag, scroll, and flick gestures similar to those implemented on computing devices equipped with a touch screen display and described above. A laptop computer 1100 will typically include a processor 1111 coupled to volatile memory 1112 and a large capacity nonvolatile memory, such as a disk drive 1113 of Flash memory. Additionally, the computer 1100 may have one or more antenna 1108 for sending and receiving electromagnetic radiation that may be connected to a wireless data link and/or cellular telephone transceiver 1116 coupled to the processor 1111. The computer 1100 may also include a floppy disc drive 1114 and a compact disc (CD) drive 1115 coupled to the processor 1111. In a notebook configuration, the computer housing includes the touchpad 1117, the keyboard 1118, and the display 1119 all coupled to the processor 1111. Other configurations of the computing device may include a computer mouse or trackball coupled to the processor (e.g., via a USB input) as are well known, which may also be used in conjunction with the various embodiments.

The various embodiments (including, but not limited to, embodiments discussed above with reference to FIGS. 1-9) may be implemented in a wide variety of computing systems, which may include any of a variety of commercially available servers for compressing data in server cache memory. An example server 1200 is illustrated in FIG. 12. Such a server 1200 typically includes one or more multi-core processor assemblies 1201 coupled to volatile memory 1202 and a large capacity nonvolatile memory, such as a disk drive 1204. As illustrated in FIG. 12, multi-core processor assemblies 1201 may be added to the server 1200 by inserting them into the racks of the assembly. The server 1200 may also include a floppy disc drive, compact disc (CD) or digital versatile disc (DVD) disc drive 1206 coupled to the processor 1201. The server 1200 may also include network access ports 1203 coupled to the multi-core processor assemblies 1201 for establishing network interface connections with a network 1205, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of accelerating execution of a plurality of tasks belonging to a common property task graph on a computing device, comprising:
identifying a first successor task dependent upon a bundled task such that an available synchronization mechanism is a common property for the bundled task and the first successor task, and such that the first successor task only depends upon predecessor tasks for which the available synchronization mechanism is a common property;
adding the first successor task to a common property task graph; and
adding the plurality of tasks belonging to the common property task graph to a ready queue.

2. The method of claim 1, further comprising:
querying a component of the computing device for the available synchronization mechanism.

3. The method of claim 1, further comprises:
creating a bundle for including the plurality of tasks belonging to the common property task graph, wherein the available synchronization mechanism is a common property for each of the plurality of tasks, and wherein each of the plurality of tasks depends upon the bundled task; and
adding the bundled task to the bundle.

4. The method of claim 3, further comprising:
setting a level variable for the bundle to a first value for the bundled task;
modifying the level variable for the bundle to a second value for the first successor task;
determining whether the first successor task has a second successor task; and
setting the level variable to the first value in response to determining that the first successor task does not have a second successor task,
wherein adding the plurality of tasks belonging to the common property task graph to a ready queue comprises adding the plurality of tasks belonging to the common property task graph to the ready queue in response to the level variable being set to the first value in response to determining that the first successor task does not have a second successor task.

5. The method of claim 1, wherein identifying a first successor task of the bundled task comprises:
determining whether the bundled task has a first successor task; and
determining whether the first successor task has the available synchronization mechanism as a common property with the bundled task in response to determining that the bundled task has the first successor task.

6. The method of claim 5, wherein identifying a first successor task of the bundled task further comprises:
deleting a dependency of the first successor task to the bundled task in response to determining that the first successor task has the available synchronization mechanism as a common property with the bundled task; and
determining whether the first successor task has a predecessor task.

7. The method of claim 6, wherein:
identifying a first successor task of the bundled task is executed recursively until determining that the bundled task has no other successor task; and
adding the plurality of tasks belonging to the common property task graph to a ready queue comprises adding the plurality of tasks belonging to the common property task graph to the ready queue in response to determining that the bundled task has no other successor task.

8. The method of claim 1, wherein the available synchronization mechanism is one of a synchronization mechanism for control logic flow and a synchronization mechanism for data access.

9. A computing device, comprising:
a memory; and
a plurality of processors communicatively connected to each other and the memory, including a first processor configured with processor-executable instructions to perform operations comprising:
identifying a first successor task dependent upon a bundled task such that an available synchronization mechanism of a second processor of the plurality of processors is a common property for the bundled task and the first successor task, and such that the first successor task only depends upon predecessor tasks for which the available synchronization mechanism is a common property;
adding the first successor task to a common property task graph; and
adding a plurality of tasks belonging to the common property task graph to a ready queue.

10. The computing device of claim 9, wherein the first processor is configured with processor-executable instructions to perform operations further comprising:
querying the second processor for the available synchronization mechanism.

11. The computing device of claim 9, wherein the first processor is configured with processor-executable instructions to perform operations further comprising:
creating a bundle for including the plurality of tasks belonging to the common property task graph, wherein the available synchronization mechanism is a common property for each of the plurality of tasks, and wherein each of the plurality of tasks depends upon the bundled task; and
adding the bundled task to the bundle.

12. The computing device of claim 11, wherein the first processor is configured with processor-executable instructions to perform operations further comprising:
setting a level variable for the bundle to a first value for the bundled task;
modifying the level variable for the bundle to a second value for the first successor task;
determining whether the first successor task has a second successor task; and
setting the level variable to the first value in response to determining that the first successor task does not have a second successor task,
wherein the first processor is configured with processor-executable instructions to perform operations such that adding the plurality of tasks belonging to the common property task graph to a ready queue comprises adding the plurality of tasks belonging to the common property task graph to the ready queue in response to the level variable being set to the first value in response to determining that the first successor task does not have a second successor task.

13. The computing device of claim 9, wherein the first processor is configured with processor-executable instructions to perform operations such that identifying a first successor task of the bundled task comprises:
determining whether the bundled task has a first successor task; and
determining whether the first successor task has the available synchronization mechanism as a common property with the bundled task in response to determining that the bundled task has the first successor task.

14. The computing device of claim 13, wherein the first processor is configured with processor-executable instructions to perform operations such that identifying a first successor task of the bundled task further comprises:
deleting a dependency of the first successor task to the bundled task in response to determining that the first successor task has the available synchronization mechanism as a common property with the bundled task; and
determining whether the first successor task has a predecessor task.

15. The computing device of claim 14, wherein the first processor is configured with processor-executable instructions to perform operations such that:
identifying a first successor task of the bundled task is executed recursively until determining that the bundled task has no other successor task; and
adding the plurality of tasks belonging to the common property task graph to a ready queue comprises adding the plurality of tasks belonging to the common property task graph to the ready queue in response to determining that the bundled task has no other successor task.

16. The computing device of claim 9, wherein the available synchronization mechanism is one of a synchronization mechanism for control logic flow and a synchronization mechanism for data access.

17. A computing device, comprising:
means for identifying a first successor task dependent upon a bundled task such that an available synchronization mechanism is a common property for the bundled task and the first successor task, and such that the first successor task only depends upon predecessor tasks for which the available synchronization mechanism is a common property;
means for adding the first successor task to a common property task graph; and
means for adding a plurality of tasks belonging to the common property task graph to a ready queue.

18. The computing device of claim 17, further comprising:
means for querying a component of the computing device for the available synchronization mechanism.

19. The computing device of claim 17, further comprises:
means for creating a bundle for including the plurality of tasks belonging to the common property task graph, wherein the available synchronization mechanism is a common property for each of the plurality of tasks, and wherein each of the plurality of tasks depends upon the bundled task; and
means for adding the bundled task to the bundle.

20. The computing device of claim 19, further comprising:
means for setting a level variable for the bundle to a first value for the bundled task;
means for modifying the level variable for the bundle to a second value for the first successor task;
means for determining whether the first successor task has a second successor task; and
means for setting the level variable to the first value in response to determining that the first successor task does not have a second successor task,
wherein means for adding the plurality of tasks belonging to the common property task graph to a ready queue comprises means for adding the plurality of tasks belonging to the common property task graph to the ready queue in response to the level variable being set to the first value in response to determining that the first successor task does not have a second successor task.

21. The computing device of claim 17, wherein means for identifying a first successor task of the bundled task comprises:
means for determining whether the bundled task has a first successor task; and
means for determining whether the first successor task has the available synchronization mechanism as a common property with the bundled task in response to determining that the bundled task has the first successor task.

22. The computing device of claim 21, wherein means for identifying a first successor task of the bundled task further comprises:
means for deleting a dependency of the first successor task to the bundled task in response to determining that the first successor task has the available synchronization mechanism as a common property with the bundled task; and
means for determining whether the first successor task has a predecessor task.

23. The computing device of claim 22, wherein:
means for identifying a first successor task of the bundled task comprises means for recursively identifying the first successor task of the bundled task until determining that the bundled task has no other successor task; and
means for adding the plurality of tasks belonging to the common property task graph to a ready queue comprises means for adding the plurality of tasks belonging to the common property task graph to the ready queue in response to determining that the bundled task has no other successor task.

24. The computing device of claim 17, wherein the available synchronization mechanism is one of a synchronization mechanism for control logic flow and a synchronization mechanism for data access.

25. A non-transitory processor-readable storage medium having stored thereon processor-executable instructions configured to cause a processor of a computing device to perform operations comprising:
identifying a first successor task dependent upon a bundled task such that an available synchronization mechanism is a common property for the bundled task and the first successor task, and such that the first successor task only depends upon predecessor tasks for which the available synchronization mechanism is a common property;
adding the first successor task to a common property task graph; and
adding a plurality of tasks belonging to the common property task graph to a ready queue.

26. The non-transitory processor-readable storage medium of claim 25, wherein the stored processor-executable instructions are configured to cause the processor to perform operations further comprising:
querying a component of the computing device for the available synchronization mechanism.

27. The non-transitory processor-readable storage medium of claim 25, wherein the stored processor-executable instructions are configured to cause the processor to perform operations further comprising:
creating a bundle for including the plurality of tasks belonging to the common property task graph, wherein the available synchronization mechanism is a common property for each of the plurality of tasks, and wherein each of the plurality of tasks depends upon the bundled task; and
adding the bundled task to the bundle.

28. The non-transitory processor-readable storage medium of claim 27, wherein the stored processor-executable instructions are configured to cause the processor to perform operations further comprising:
setting a level variable for the bundle to a first value for the bundled task;
modifying the level variable for the bundle to a second value for the first successor task;
determining whether the first successor task has a second successor task; and
setting the level variable to the first value in response to determining that the first successor task does not have a second successor task,
wherein adding the plurality of tasks belonging to the common property task graph to a ready queue comprises adding the plurality of tasks belonging to the common property task graph to the ready queue in response to the level variable being set to the first value in response to determining that the first successor task does not have a second successor task.

29. The non-transitory processor-readable storage medium of claim 25, wherein the stored processor-executable instructions are configured to cause the processor to perform operations such that identifying a first successor task of the bundled task comprises:
determining whether the bundled task has a first successor task; and
determining whether the first successor task has the available synchronization mechanism as a common property with the bundled task in response to determining that the bundled task has the first successor task.

30. The non-transitory processor-readable storage medium of claim 29, wherein the stored processor-executable instructions are configured to cause the processor to perform operations such that identifying a first successor task of the bundled task further comprises:
deleting a dependency of the first successor task to the bundled task in response to determining that the first successor task has the available synchronization mechanism as a common property with the bundled task; and
determining whether the first successor task has a predecessor task.

31. The non-transitory processor-readable storage medium of claim 30, wherein the stored processor-executable instructions are configured to cause the processor to perform operations such that:
identifying a first successor task of the bundled task is executed recursively until determining that the bundled task has no other successor task; and
adding the plurality of tasks belonging to the common property task graph to a ready queue comprises adding the plurality of tasks belonging to the common property task graph to the ready queue in response to determining that the bundled task has no other successor task.

32. The non-transitory processor-readable storage medium of claim 25, wherein the available synchronization mechanism is one of a synchronization mechanism for control logic flow and a synchronization mechanism for data access.
